(19) United States
(12) Patent Application Publication
(10) Pub. No.: US 2006/0142057 A1
(43) Pub. Date: Jun. 29, 2006

(54) Med-phone

(76) Inventors: Beverly Schuler, St. Charles, IL (US); Karla Reiss-Sitko, St. Charles, IL (US)

Correspondence Address: JAMES RAY & ASSOCIATES, 2640 Pitcaim Road, Monroeville, PA, 15146, US

(21) Appl. No.: 11/274,640

(22) Filed: Nov. 15, 2005

Related U.S. Application Data
(60) Provisional application No. 60/635,136, filed on Dec. 10, 2004.

(51) Int. Cl. H04M 1/00; G06F 19/00; G06K 19/06

(52) U.S. Cl. 455/556.1; 705/3; 235/492

(57) ABSTRACT

An apparatus to enable an individual to input, access, store and revise pertinent medical and other relevant information. The apparatus comprises a cell phone having a computer chip installed in the cell phone for inputting and storing selected medical and other relevant information. A number sequence code connected for communication with the computer chip is provided for updating said medical and other relevant information stored on the computer chip and a button above such keypad also connected for communication with the computer chip is provided for accessing the medical and other relevant information stored on the computer chip by emergency medical personnel.

### CROSS REFERENCE TO RELATED APPLICATIONS

This application is closely related to and claims benefit from U.S. Provisional Application Ser. No. 60/635,136 filed Dec. 10, 2004.

### FIELD OF THE INVENTION

The present invention relates, in general, to a cell phone, and, more particularly, this invention relates to a cell phone that is capable of storing personal medical information or data regarding the medical history of the user which can be accessed in case of an emergency.

### BACKGROUND OF THE INVENTION

Often, in the midst of a medical emergency, the patient cannot speak for themselves whether its because the patient is unconscious or is incapacitated in another way. In these cases, it is vital that there is some way that the patient can communicate his/her current medical condition, medications, allergies or other important medical information to the emergency medical personnel. The information is extremely important for the medical personnel to have since it may change the way the patient is treated. This is true whether the emergency medical personnel are paramedics assigned to an ambulance or doctors or nurses in an emergency room.

In the event of an accident or any other medical emergency such as a stroke or heart attack the information is extremely important. Thus, it is very important that there be some manner in which a patient's pertinent medical history, medications, patient's doctors and/or specialists, even down to the patient's name, address, and phone number be provided to medical personnel if the patient can not communicate in any way.

### SUMMARY OF THE INVENTION

Thus, a first embodiment the present invention provides an apparatus to enable an individual to input, access, store and revise pertinent medical and other relevant information. The apparatus comprises a cell phone having a computer chip installed in the cell phone for inputting and storing selected medical and other relevant information. A first means connected for communication with the computer chip is provided for updating said medical and other relevant information stored on the computer chip and a second means also connected for communication with the computer chip is provided for accessing the medical and other relevant information stored on the computer chip.

### OBJECTS OF THE INVENTION

It is, therefore, one of the primary objects of the present invention to provide a cell phone capable of storing personal medical information or data regarding medical history of the user.

Another object of the present invention is to provide a cell phone that is programmable.

Yet, another object of the present invention is to provide a cell phone which can be accessed by emergency medical personnel.

Still another object of the present invention is to provide a cell phone which can be updated by the user when there are any changes in such medical history.

It is another object of the present invention to provide a cell phone which has the medical symbol disposed on the cell phone.

In addition to the various objects and advantages of the invention which have been described in some specific detail above it should be noted that various other objects and advantages of the present invention will become more readily apparent to those persons who are skilled in the relevant art from the following more detailed description, particularly when such description is taken in conjunction with the appended claims.

### BRIEF DESCRIPTION OF THE DRAWINGS

FIG. 1 is a partial perspective view of an open cell phone with the medical insignia button above the keypad.

FIG. 2 is drawing of the medical alert symbol disposed on the cell phone.

FIG. 3 is a partial block diagram showing the relationship of the important features of the invention.

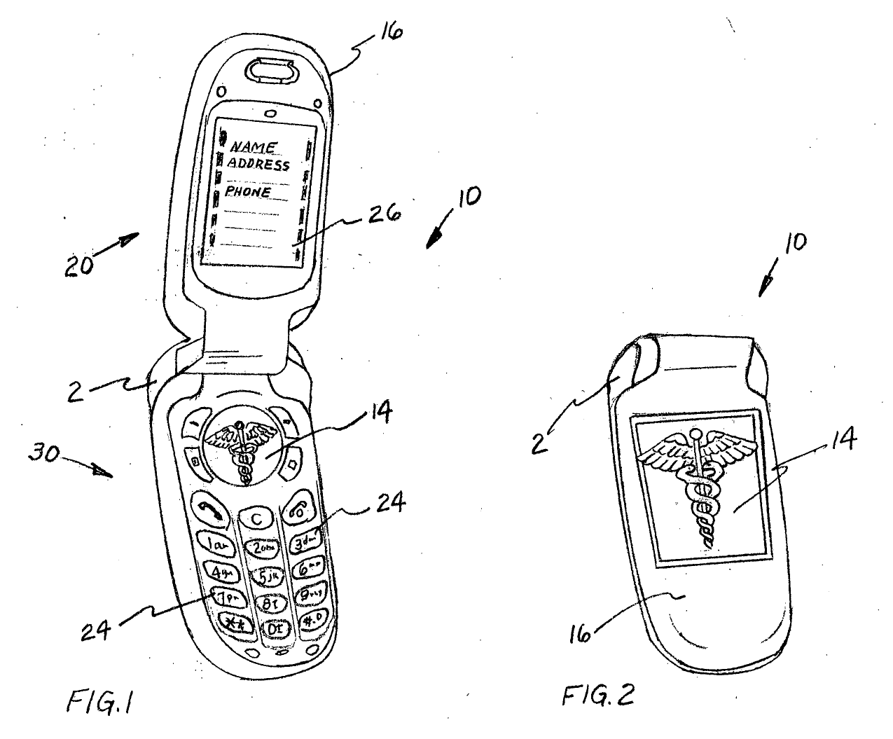

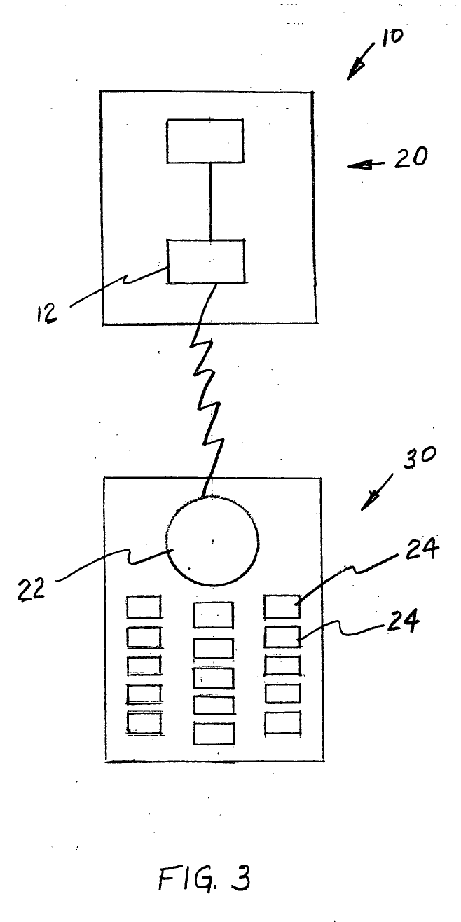

### BRIEF DESCRIPTION OF THE PRESENTLY PREFERRED AND VARIOUS ALTERNATIVE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first embodiment the present invention provides an apparatus, generally designated 10, to enable an individual to input, access, store and revise pertinent medical and other relevant information.

The apparatus 10 comprises a cell phone 2 having a computer chip 12 installed in the cell phone 2 for inputting and storing selected medical and other relevant information. A first means, generally designated 20, connected for communication with the computer chip 12 is provided for updating the medical and other relevant information stored on the computer chip 12 and a second means, generally designated 30, also connected for communication with the computer chip 12 is provided for accessing the medical and other relevant information stored on the computer chip 12.

Such cell phone 2 would also have a medical symbol (caduceus) 14 disposed either on the outside of the cell phone 2 or on the flip portion 16 of the phone. It is presently preferred that such medical symbol 14 is disposed on the outside of the cell phone 2 so it would be immediately visible to all emergency medical personnel and alert them that the cell phone 2 includes medical data.

In a preferred embodiment of the invention such means 30 for accessing the medical information includes a button 22 disposed on the cell phone 2 above a keypad 24 of the cell phone 2. It is further preferred that such button 22 display the medical symbol 14. Again the medical symbol 14 is used to alert medical personnel to push the button 22 to access medical history or information about the patient.

Some of the medical information stored on the computer chip 12 would include at least significant illnesses, diseases, heart problems, diabetes, current medications, allergies, immunizations, current doctors, specialists, medical and surgical history, and results of lab tests.

Such computer chip 12 would also store other selected personal information. Such selected personal information would at least include name, address, date of birth, height, weight, hair color, eye color, religion, contact person in event of emergency and insurance.

Thus, the computer chip 12 would have all this information readily available to such emergency medical personnel and could be accessed by just pushing the button 22 with the medical insignia 14 disposed thereon. All of this information could be displayed on the screen 26 of the cell phone 2.

Such means 20 connected for communication with the computer chip 12 can be accessed by the user of the cell phone for updating such medical and other relevant information stored on said computer chip by using a preprogrammed code. It is presently preferred that such preprogrammed code would include a number sequence on the keypad 24. Such number sequence may be a birthday or any other number sequence selected by the user. The use of the code for updating the information prevents any accidental altering of such medical or other relevant information.

As stated previously the information stored on the computer chip 12 would include a medical history and any other relevant information, which would include, at least, medications currently being taken, allergies, heart conditions, blood thinners, pacemakers, diabetes, epilepsy or any other disease. All this information can be accessed immediately, and, thus, it can be used before treatment begins in an emergency room or even by paramedics in case of an accident or an emergency call, perhaps saving the persons life. The immediate accessibility of this information can also protect the caregivers, as it will greatly reduce the number of errors made in treating patients with existing medical conditions.

The med-phone is a standard flip-type cell phone 2 that would have a medical insignia 14 on the outside of the phone 2 or on the flip portion 16 of the phone 2. A computer chip 12 would be installed in the phone to hold all of the medical information pertaining to the user. A password or a code, such as a preprogrammed code number sequence on the phone keypad would provide access for updating and changing such medical information. Such code could be a birth date (Nov. 12, 1946), or any other number sequence selected by the owner. A button 22 above the key pad with the medical insignia disposed on the button would be used for such emergency medical personnel to access such medical information. The medical insignia 14 on the phone 2 would alert medical personnel that the phone holds vital medical information.

The following information would be programmed into the cell phone:

General Information: name, date of birth, height weight, hair color, eye color, religion, emergency contact person along with their relationship, address and phone number.

Medical Information: illnesses, diseases, current medications, allergies, names and addresses of all physicians such as primary care and specialists; heart conditions, such as blood thinners or pacemakers; presence or absence of a ADo Not Resuscitate Order@ (DNR); or a Living Will; also medical insurance, primary and/or secondary. A driver's license or a birth date could be used for identifying purposes.

It should also be recognized that this information can be forwarded to a hospital by a wireless connection to expedite treatment if necessary.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

We claim:

1. An apparatus to enable an individual to input, access, store and revise pertinent medical and other relevant information, said apparatus comprising:
(a) a cell phone;
(b) a computer chip installed in said cell phone for inputting and storing selected medical and other relevant information;
(c) a first means connected for communication with said computer chip for updating said medical and other relevant information stored on said computer chip; and
(d) a second means connected for communication with said computer chip for accessing said medical and other relevant information stored on said computer chip.

2. The apparatus, according to claim 1, wherein said selected medical information includes at least significant illnesses, diseases, heart problems, diabetes, current medications, allergies, immunizations, current doctors, specialists, medical and surgical history, and results of lab tests.

3. The apparatus, according to claim 1, wherein said other relative information stored on said computer chip includes selected personal information.

4. The apparatus, according to claim 3, wherein said selected personal information would at least include name, address, date of birth, height, weight, hair color, eye color, religion, contact person in event of emergency and insurance.

5. The apparatus, according to claim 1, wherein said cell phone further includes a button disposed on said cell phone above a keypad of said cell phone.

6. The apparatus, according to claim 5, wherein said button disposed on said cell phone above said keypad of said cell phone displays a medical insignia.

7. The apparatus, according to claim 5, wherein said button with said medical insignia displayed thereon is used to access said medical and other relevant information stored on said computer chip.

8. The apparatus, according to claim 1, wherein said cell phone would display such medical and other relevant information on a screen on said cell phone.

9. The apparatus, according to claim 1, wherein said second means connected for communication with said computer chip for accessing said medical and other relevant information stored on said computer chip includes a preprogrammed code.

10. The apparatus, according to claim 9, wherein said preprogrammed code includes a number sequence.

11. The apparatus, according to claim 1, wherein said cell phone further includes a medical symbol displayed on an outside surface of said cell phone.

12. The apparatus, according to claim 1, wherein said apparatus further includes the capability of forwarding medical information via a wireless connection.
